(19) United States
(12) Patent Application Publication
(10) Pub. No.: US 2026/0274751 A1
(43) Pub. Date: Sep. 17, 2026

(54) SUSTAINABLE BRICK COMPOSITION AND METHOD OF PREPARATION THEREOF

(71) Applicant: KING FAHD UNIVERSITY OF PETROLEUM AND MINERALS, Dhahran (SA)

(72) Inventors: Omar Atef RADWAN, Dhahran (SA); Mohamed Abdrabou HUSSEIN, Dhahran (SA); Rida Alwi ASSAGGAF, Dhahran (SA); John Dean HUMPHREY, Dhahran (SA)

(73) Assignee: KING FAHD UNIVERSITY OF PETROLEUM AND MINERALS, Dhahran (SA)

(21) Appl. No.: 19/078,427

(22) Filed: Mar. 13, 2025

(51) Int. Cl. C04B 28/14; C04B 14/04; C04B 14/06

(52) U.S. Cl. CPC C04B 28/141; C04B 14/042; C04B 14/06

(57) ABSTRACT

A method of brick production includes mixing an uncalcined gypsum powder and a quartz material to form a mixture, mixing the mixture with water to form a composition, cold sintering the composition in a mold at a pressure of 50 to 450 megapascal (MPa) at room temperature for 20 to 40 minutes (min), and drying the cold sintered compositions for 5 to 10 days at a maximum temperature of 50 degrees Celsius (° C.) in a sealed container to form a brick. The quartz material is selected from a group consisting of a quartz sand and a quartz powder. A weight ratio of the uncalcined gypsum powder to the quartz material is from 5:95 to 95:5. A weight ratio of the water to the mixture is from 0.01:1 to 0.15:1.

### STATEMENT REGARDING PRIOR DISCLOSURE BY THE INVENTORS

Aspects of the present disclosure are described in Radwan, O. A. et al., “Rebuilding with sand roses: Cold sintering of sand-gypsum mixture for sustainable brick production” published in Volume 442, Construction and Building Materials, which is incorporated herein by reference in its entirety.

### STATEMENT OF ACKNOWLEDGEMENT

Support provided by the College of Petroleum Engineering & Geosciences, King Fahd University of Petroleum and Minerals, Saudi Arabia is gratefully acknowledged.

### BACKGROUND

### Technical Field

The present disclosure is directed towards a method of brick production, and more particularly, towards a method of brick production by cold sintering an uncalcined gypsum powder, a quartz material, and water at room temperature.

### Description of Related Art

The “background” description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Traditional brick production methods, including the manufacturing of fired clay and concrete bricks, are characterized by high energy consumption, a substantial carbon footprint, and the depletion of natural resources including soil and freshwater. Various alternatives have been proposed to replace conventional bricks and brick production methods, including incorporating municipal and industrial waste materials to reduce depletion of natural resources; however, these approaches still involve high temperature firing processes which results in large energy consumption and carbon emissions. While waste materials are abundant, they remain a limited resource for global brick industries. Other brick production methods focus on using low-temperature stabilization techniques, such as geopolymerization, to reduce energy consumption and a carbon footprint; however, the geopolymerization process still relies on materials with high energy and large carbon footprints, such as calcined clay and sodium hydroxide.

A need for developing a brick production method that maintains standards specified for building bricks while addressing sustainability concerns exists. Accordingly, an object of the present disclosure is to provide a method for producing a sustainable brick composition that may circumvent the drawbacks and limitations, such as high energy consumption, excessive carbon emissions, and high costs, of the materials and methods already known in the art.

### SUMMARY

In an exemplary embodiment, a method of brick production is described. The method includes mixing an uncalcined gypsum powder and a quartz material to form a mixture, mixing the mixture with water to form a composition, cold sintering the composition in a mold at a pressure of 50 to 450 megapascal (MPa) at room temperature for 20 to 40 minutes (min), and drying the cold sintered compositions for 5 to 10 days at a maximum temperature of 50 degrees Celsius (° C.) in a sealed container to form a brick. The quartz material is selected from a group consisting of a quartz sand and a quartz powder. A weight ratio of the uncalcined gypsum powder to the quartz material is from 5:95 to 95:5. A weight ratio of the water to the mixture is from 0.01:1 to 0.15:1.

In some embodiments, the weight ratio of the uncalcined gypsum powder to the quartz material is 90:10 and the compressive strength of the brick is 35 to 42 MPa.

In some embodiments, the quartz material is quartz sand, and the compressive strength of the brick is 39 to 41 MPa.

In some embodiments, the weight ratio of the uncalcined gypsum powder to the quartz material is 70:30 and the compressive strength of the brick is 20 to 35 MPa.

In some embodiments, the cold sintering process is selected from a group consisting of static loading and cyclic loading.

In some embodiments, the cold sintering process includes cyclic loading including 80 to 120 cycles of repetitive applied pressure followed by no applied pressure.

In some embodiments, after cold sintering with cyclic loading the brick has a compressive strength 1.5 to 5 times greater than a brick cold sintered with static loading.

In some embodiments, the method further includes mixing a talc with the uncalcined gypsum powder and the quartz material in an amount of 2 to 6 weight percent (wt. %) based on the total weight of the mixture.

In some embodiments, the method further includes mixing a calcium carbonate powder with water to form a calcium carbonate mixture, coating an outer surface of the brick with 1 to 5 layers of the calcium carbonate mixture, cold sintering the calcium carbonate coated brick with cyclic loading at a pressure of 80 to 120 MPa at room temperature for 10 to 20 min, and drying the cold sintered calcium carbonate coated brick for 5 to 10 days at 50° C. A weight ratio of the water to the calcium carbonate powder in the mixture is from 0.05:1 to 0.25:1.

In some embodiments, the calcium carbonate mixture includes malachite and azurite.

In some embodiments, the uncalcined gypsum powder is calcium sulfate dihydrate (CaSO₄·2H₂O).

In some embodiments, a median particle size for the quartz sand is 350 to 390 micrometers (μm).

In some embodiments, a median particle size for the quartz powder is 10 to 20 μm.

In some embodiments, the uncalcined gypsum powder has an average particle size of 100 to 130 μm.

In some embodiments, the calcium carbonate powder includes 25 to 30 wt. % calcite and 70 to 75 wt. % aragonite based on a total weight of the calcium carbonate powder.

In some embodiments, the mixing, cold sintering and drying are carried out in the absence of a cement and/or a calcined gypsum.

In some embodiments, the cold sintered calcium carbonate coated brick includes a water-resistant calcium carbonate layer on the brick.

In some embodiments, the water-resistant calcium carbonate layer has a thickness of 0.5 to 3 centimeters (cm) on the outer surface of the brick.

In some embodiments, the method further includes grinding the brick to form a recycled material, cold sintering the recycled material in a mold, and drying the cold sintered recycled material to form a recycled brick.

In some embodiments, the recycled brick has a compressive strength 1.4 to 2 times greater than the brick.

The foregoing general description of the illustrative present disclosure and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A is a flow chart of a method of brick production, according to certain embodiments.

FIG. 1B (top) is a cumulative particle size distribution graph of quartz sand, quartz powder, gypsum powder, and calcium carbonate powder and (bottom) X-ray diffraction (XRD) patterns of quartz sand, quartz powder, gypsum powder, and calcium carbonate powder, according to certain embodiments.

FIG. 2A depicts effects of gypsum percentage and quartz grain size on unconfined compressive strength (UCS) of a cold-sintered mixture of gypsum powder (G) with either quartz sand (Q) or quartz powder (q), according to certain embodiments. Cold sintering was conducted with a static pressure of 300 megapascals (MPa) for 30 minutes (min).

FIG. 2B depicts effects of talc percentage on the UCS of a cold-sintered mixture (static pressure of 300 MPa for 15 minutes) of equal proportion of gypsum powder and quartz powder, according to certain embodiments.

FIG. 2C depicts effects of increasing applied pressure on the UCS of cold-sintered mixtures (static pressure for 30 minutes) of gypsum powder and quartz sand, according to certain embodiments.

FIG. 2D depicts effects of loading mode (static vs. cyclic) on the UCS of cold-sintered mixtures (pressure of 400 MPa for 30 min) of gypsum powder and quartz sand, according to certain embodiments.

FIG. 2E depicts effects of cyclic loading (100 cycles) on the UCS of cold-sintered gypsum-quartz sand mixtures (applied pressure for 30 min), according to certain embodiments.

FIG. 2F depicts effects of recycling on the UCS of cold-sintered mixtures (cyclic (15 cycles) loading at a pressure of 300 MPa for 15 min) of equal proportion of gypsum powder and quartz, according to certain embodiments.

FIG. 3A depicts effects of applying a calcium carbonate coating on the UCS of a cold-sintered mixture (static pressure of 300 MPa for 15 min) of gypsum powder (50 wt. %) with quartz sand (50 wt. %), according to certain embodiments.

FIG. 3B is a photomicrograph taken under a stereomicroscopic viewing of a cold-sintered gypsum powder-quartz sand mixture, according to certain embodiments.

FIG. 3C is a photomicrograph of a side view of a cold sintered mixture of gypsum powder and quartz sand with an upper and lower calcium carbonate coating, according to certain embodiments.

FIG. 3D is a photomicrograph of a top view of the calcium carbonate coating mixed with azurite and malachite, according to certain embodiments.

FIG. 4A is a scanning electron microscopy (SEM) image of a boundary between an upper coating (mixture of calcium carbonate powder, azurite and malachite) and a lower cold-sintered gypsum powder-quartz sand mixture with a scale of 500 micrometer (μm), according to certain embodiments.

FIG. 4B is an SEM image of a recycled cold-sintered gypsum powder-quartz sand mixture with a scale of 500 μm, according to certain embodiments.

FIG. 4C is an energy-dispersive X-ray spectroscopy (EDS) elemental mapping image of a coated (mixture of calcium carbonate powder, azurite and malachite) cold-sintered gypsum powder-quartz sand mixture depicting silicon (Si), according to certain embodiments.

FIG. 4D is an EDS elemental mapping image of a coated (mixture of calcium carbonate powder, azurite and malachite) cold-sintered gypsum powder-quartz sand mixture depicting oxygen (O), according to certain embodiments.

FIG. 4E is an EDS elemental mapping image of a coated (mixture of calcium carbonate powder, azurite and malachite) cold-sintered gypsum powder-quartz sand mixture depicting calcium (Ca), according to certain embodiments.

FIG. 4F is an EDS elemental mapping image of a coated (mixture of calcium carbonate powder, azurite and malachite) cold-sintered gypsum powder-quartz sand mixture depicting sulfur (S), according to certain embodiments.

FIG. 4G is an EDS elemental mapping image of a coated (mixture of calcium carbonate powder, azurite and malachite) cold-sintered gypsum powder-quartz sand mixture depicting copper (Cu), according to certain embodiments.

FIG. 4H is an EDS elemental mapping image of a coated (mixture of calcium carbonate powder, azurite and malachite) cold-sintered gypsum powder-quartz sand mixture depicting magnesium (Mg), according to certain embodiments.

FIG. 4I is an EDS elemental mapping image of a recycled cold-sintered gypsum powder-quartz sand mixture depicting Si, according to certain embodiments.

FIG. 4J is an EDS elemental mapping image of a recycled cold-sintered gypsum powder-quartz sand mixture depicting O, according to certain embodiments.

FIG. 4K is an EDS elemental mapping image of a recycled cold-sintered gypsum powder-quartz sand mixture depicting Ca, according to certain embodiments.

FIG. 4L is an EDS elemental mapping image of a recycled cold-sintered gypsum powder-quartz sand mixture depicting S, according to certain embodiments.

FIG. 4M is an SEM image of a coated (mixture of calcium carbonate powder, azurite and malachite) cold-sintered gypsum powder-quartz sand mixture with a scale of 200 μm, according to certain embodiments.

FIG. 4N is an SEM image of a recycled cold-sintered gypsum powder-quartz sand mixture with a scale of 200 μm, according to certain embodiments.

### DETAILED DESCRIPTION

When describing the present disclosure, the terms used are to be construed in accordance with the following definitions, unless a context dictates otherwise.

Embodiments of the present disclosure will now be described more fully hereinafter with reference to the accompanying drawings wherever applicable, in that some, but not all, embodiments of the disclosure are shown.

In the drawings, like reference numerals will be used to designate identical or corresponding parts throughout the several views. Further, as used herein, the words “a,” “an,” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

When amounts, concentrations, dimensions, and other parameters are expressed in the form of a range, a preferable range, an upper limit value, a lower limit value or preferable upper and limit values, it should be understood that any ranges obtainable by combining any upper limit or preferable value with any lower limit or preferable value are also specifically disclosed, irrespective of whether the obtained ranges are clearly mentioned in the context.

As used herein, the term “amount” refers to a mass, level, and/or concentration of one or more reactants, catalysts, and/or materials present in a reaction mixture.

As used herein, the term “particle” refers to an object that acts as a whole unit with regard to its transport and properties.

As used herein, the term “particle size” refers to a length or longest dimension of a particle. The greatest distance that can be measured from one point on a shape through its center to a point directly across from it may be referred to as the “diameter” for a circle, oval, ellipse, and multilobe.

As used herein, the term “room temperature” refers to a temperature range of 25±3 degrees Celsius (° C.) in the present disclosure.

As used herein, the term “mold” refers to a hollow container used to shape and/or form materials into a specific shape and/or pattern by pouring and/or pressing the material into it.

As used herein, the term “compressive strength” refers to the ability of a material to bear axial loads that tend to reduce its size. This capacity is commonly determined by the greatest compressive stress a material can sustain before failing.

As used herein, the term “cold sintering” refers to a low-temperature process that uses pressure to consolidate materials into dense solids. It may be used for materials that are sensitive to high temperatures, such as polymers, certain ceramics, and composites, as it reduces energy consumption and preserves the integrity of the materials.

As used herein, the term “median particle size” refers to the size at which half of the particles in a sample are smaller and the other half are larger, representing the central point of a particle size distribution.

The present disclosure is intended to include all hydration states of a given compound or formula, unless otherwise noted or when heating a material.

In addition, the present disclosure is intended to include all isotopes of atoms occurring in the present compounds and complexes. Isotopes include those atoms having the same atomic number but different mass numbers. By way of general example, and without limitation, isotopes of hydrogen include deuterium and tritium, and isotopes of carbon include ¹³C and ¹⁴C. Isotopes of oxygen include ¹⁶O, ¹⁷O, and ¹⁸O. Isotopically-labeled compounds of the disclosure may generally be prepared by conventional techniques known to those skilled in the art or by processes analogous to those described herein, using an appropriate isotopically-labeled reagent in place of the non-labeled reagent otherwise employed.

Aspects of the present disclosure are directed to a formulation and method to fabricate sustainable bricks that can be utilized in the climate of the Arabian Peninsula and other climate conditions. The method involves using room-temperature cold sintering to densify mixtures of sand and gypsum. The method may optionally use a calcium carbonate coating over the sand-gypsum mixture to protect against weathering agents. Cold-sintered sand-gypsum mixtures containing over 30% micron-sized gypsum may achieve greater unconfined compressive strength values compared to concrete bricks of the same size.

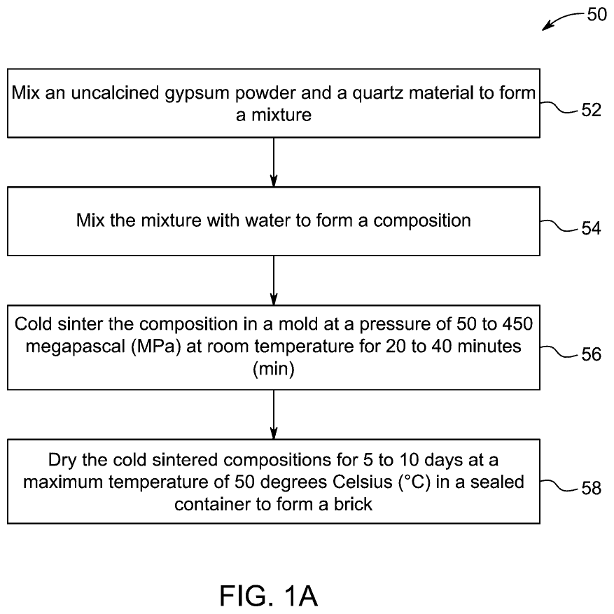

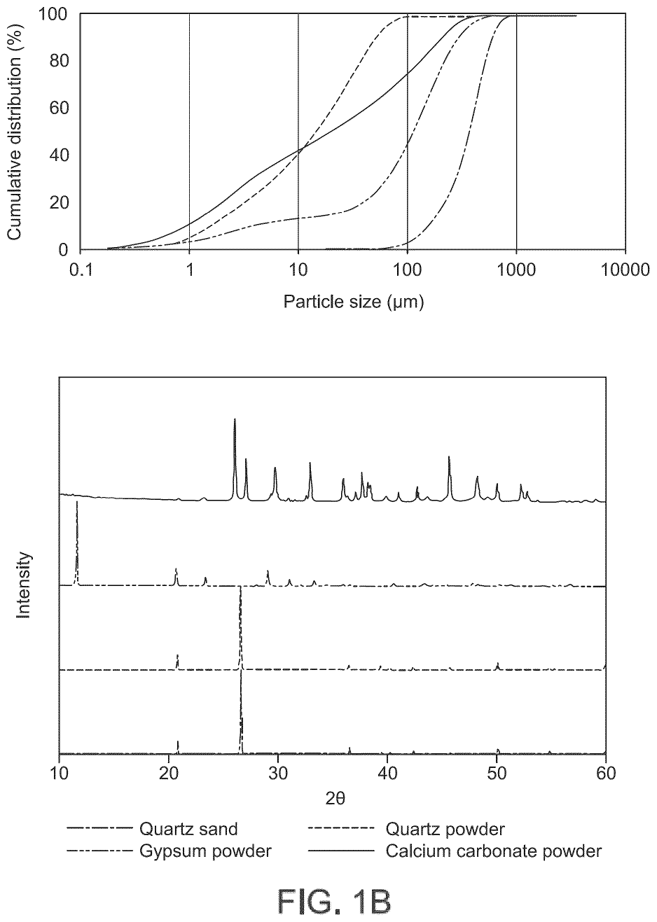

FIG. 1A illustrates a flow chart of a method 50 of brick production. The order in which the method 50 is described is not intended to be construed as a limitation, and any number of the described method steps can be combined in any order to implement the method 50. Additionally, individual steps may be removed or skipped from the method 50 without departing from the spirit and scope of the present disclosure.

At step 52, the method 50 includes mixing an uncalcined gypsum powder and a quartz material to form a mixture. Gypsum is a soft sulfate mineral composed of calcium sulfate (CaSO₄) that is widely utilized in the construction industry due to its versatility. Gypsum may be a calcined gypsum (CaSO₄·0.5H₂O), also known as plaster of Paris or stucco, which has been heated to remove most of its water content. Calcined gypsum primarily consists of calcium sulfate hemihydrate (CaSO₄·0.5H₂O). Producing calcined gypsum involves heating gypsum to about 150 to 180° C. to partially dehydrate the mineral. Calcined gypsum is commonly used in the production of plaster, drywall, and cement, offering benefits like improved fire resistance and sound insulation. When processed, gypsum forms a lightweight material that is easy to handle and mold, making it applicable for both residential and commercial buildings. Gypsum may also be an uncalcined gypsum, which is a naturally occurring mineral in its hydrated form, mostly composed of calcium sulfate dihydrate (CaSO₄·2H₂O). Uncalcined gypsum may be found in layers of sedimentary rock and large evaporite deposits. The gypsum powder of the current disclosure is an uncalcined gypsum powder.

Quartz is a strong, crystalline mineral made up of silicon dioxide that is commonly found in nature. It is widely used in the construction industry, particularly as an aggregate in concrete and mortar mixtures due to its strength and durability. When mixed with materials like cement or gypsum, quartz may help improve the overall structural integrity and longevity of the mixture. Its resistance to abrasion and weathering makes it a candidate for creating long-lasting, resilient building materials that are suitable for a variety of construction applications, from flooring to countertops. The quartz material is selected from a group consisting of a quartz sand and a quartz powder. Quartz sand, a coarse form of silica, may provide strength and stability to a mixture, while quartz powder, being finely ground, may improve texture and bonding properties of a mixture. Both forms may be selected based on characteristics of a final product. In some embodiments, the quartz sand and the quartz powder may be used in combination with the uncalcined gypsum powder to form the mixture.

Sand and gypsum are widely available geomaterials. Eolian (also known as aeolian) sands encompass about 6% of global land surfaces, with one-third of the Arabian Peninsula being covered by sand, constituting the largest uninterrupted expanse of eolian sand on the planet. Gypsum is obtained through mining and/or quarrying processes. Mining may involve extracting gypsum from relatively shallow depths. In the southern hemisphere, large amounts of gypsum are quarried from coastal lakes formed during the Holocene period in southern and western Australia. Gypsum crusts are present extensively in warm deserts across the globe, typically in areas with a gypsum source and an annual rainfall of less than 250 millimeters (mm). Gypsum is encountered as loosely powdered and/or solidified crystalline accumulations, existing either on a surface or within the uppermost 10 meters of a regolith. Thicknesses range from a few millimeters to several meters, with purities spanning from around 15% to nearly 100% gypsum. The Arabian Peninsula possesses large gypsum reserves, with Oman and Saudi Arabia ranking among the top gypsum-producing countries, generating approximately 12 and 4 million tons in 2022, respectively.

Inclusion of gypsum in bricks may offer benefits in terms of fire resistance. Gypsum is inherently fire-resistant due to the presence of water molecules within its crystalline structure. When exposed to fire, the water content in gypsum is released as steam, which helps to retard the spread of flames and heat. Gypsum-based materials made from calcined gypsum (commonly known as plaster of Paris) offer heat insulation which contributes to energy savings over the lifetime of a building. This leads to lower utility bills and a decreased reliance on fossil fuels, contributing to environmental sustainability; however, the heat insulation of gypsum derived from calcined gypsum is partially attributed to its porous structure. The gypsum utilized in the present disclosure, uncalcined gypsum, is nearly non-porous.

Gypsum produced as a byproduct of other industries can be recycled and used as a binder in bricks. Solar saltworks are areas where halite is produced through a natural process of solar evaporation of seawater. These operations typically consist of large shallow ponds or basins designed to capture and utilize energy from the sun to evaporate water, leaving behind crystallized salt. Evaporating 1 kilometer (km) of seawater leads to the sequential precipitation of approximately 20 centimeters (cm) of carbonate minerals, 1 meter (m) of gypsum, 12 m of halite, and 2.5 m of bittern salts. Carbonate minerals and gypsum are extracted as byproducts before precipitating halite.

Phosphogypsum, fluorogypsum, citrogypsum, borogypsum, titanogypsum, and desulfogypsum are all types of synthetic gypsum, which is a byproduct of various industrial processes. Phosphogypsum is a byproduct in the production of phosphate fertilizers. Fluorogypsum, citrogypsum, and borogypsum are byproducts in the production of hydrofluoric acid, citric acid, and boric acid, respectively. Titanogypsum is a byproduct of the production of titanium dioxide pigment. Desulfogypsum is produced in the desulfurization process of flue gas from power plants and/or industrial facilities. Ongoing endeavors are directed toward recycling and the exploration of applications for synthetic gypsum, particularly within the realm of construction applications. Synthetic gypsum shares an identical chemical composition and crystal structure with natural gypsum. Typically, it exhibits a higher dihydrate content and purity compared to the majority of natural gypsum; however, variations exist in the distribution of impurities, which, in certain instances of synthetic gypsum, may raise environmental concerns.

In the Arabian Peninsula, gypsum is being produced as a byproduct of several industries including the production of sea salt and phosphogypsum. The Saline Water Conversion Corporation (SWCC) is leading a major effort to construct a desalination plant in Shoaiba, Saudi Arabia.

Mixing techniques include, but are not limited to, stirring, sonication, rotary drum mixing, planetary mixing, high shear mixing, vortex mixing, ribbon blending, hand mixing, ball milling, a combination thereof, and the like. A weight ratio of the uncalcined gypsum powder to the quartz material is from 5:95 to 95:5, preferably 10:90 to 90:10, preferably 15:85 to 85:15, preferably 20:80 to 80:20, preferably 25:75 to 75:25, preferably 30:70 to 70:30, preferably 35:65 to 65:35, preferably 40:60 to 60:40, preferably 45:55 to 55:45, and preferably about 50:50.

At step 54, the method 50 includes mixing the mixture with water to form a composition. The water may be tap water, distilled water, bidistilled water, deionized water, deionized distilled water, reverse osmosis water, salt water, wastewater, a combination thereof, and/or some other water. In a preferred embodiment, the water is distilled water. The mixture and water may be mixed manually or with the help of a stirrer. A weight ratio of the water to the mixture is from 0.01:1 to 0.15:1, preferably 0.02:1 to 0.14:1, preferably 0.03:1 to 0.13:1, preferably 0.04:1 to 0.12:1, preferably 0.05:1 to 0.11:1, preferably 0.06:1 to 0.1:1, preferably 0.07:1 to 0.09:1, and preferably about 0.08:1.

At step 56, the method 50 includes cold sintering the composition in a mold at a pressure of 50 to 450 megapascal (MPa), preferably 60 to 440 MPa, preferably 70 to 430 MPa, preferably 80 to 420 MPa, preferably 90 to 410 MPa, preferably 100 to 400 MPa, preferably 110 to 390 MPa, preferably 120 to 380 MPa, preferably 130 to 370 MPa, preferably 140 to 360 MPa, preferably 150 to 350 MPa, preferably 160 to 340 MPa, preferably 170 to 330 MPa, preferably 180 to 320 MPa, preferably 190 to 310 MPa, preferably 200 to 300 MPa, preferably 210 to 290 MPa, preferably 220 to 280 MPa, preferably 230 to 270 MPa, and preferably 240 to 260 MPa at room temperature for 20 to 40 minutes (min), preferably 21 to 39 min, preferably 22 to 38 min, preferably 23 to 37 min, preferably 24 to 36 min, preferably 25 to 35 min, preferably 26 to 34 min, preferably 27 to 33 min, preferably 28 to 32 min, and preferably 29 to 31 min. In some embodiments, the method includes cold sintering the composition in a mold at a pressure of about 300 MPa at room temperature for about 30 min.

In some embodiments, the cold sintering process is selected from a group consisting of static loading and cyclic loading. Static loading involves applying a continuous pressure over a period of time to the material, while cyclic loading involves applying a varying pressure over a period of time, both contributing to the bonding and structural integrity of the material. In some embodiments, the cold sintering process includes cyclic loading including 80 to 120 cycles, preferably 85 to 115 cycles, preferably 90 to 110 cycles, preferably 95 to 105 cycles, and preferably about 100 cycles of repetitive applied pressure followed by no applied pressure.

In some embodiments, after cold sintering with cyclic loading the brick has a compressive strength 1.5-5 times, preferably 1.6-4.9 times, preferably 1.7-4.8 times, preferably 1.8-4.7 times, preferably 1.9-4.6 times, preferably 2-4.5 times, preferably 2.1-4.4 times, preferably 2.2-4.3 times, preferably 2.3-4.2 times, preferably 2.4-4.1 times, preferably 2.5-4 times, preferably 2.6-3.9 times, preferably 2.7-3.8 times, preferably 2.8-3.7 times, preferably 2.9-3.6 times, preferably 3-3.5 times, preferably 3.1-3.4 times, and preferably 3.2-3.3 times greater than a brick cold sintered with static loading. In one embodiment, after cold sintering with cyclic loading the brick has a compressive strength about 1.7 times greater than a brick cold sintered with static loading. In another embodiment, after cold sintering with cyclic loading the brick has a compressive strength about 3.4 times greater than a brick cold sintered with static loading.

At step 58, the method 50 includes drying the cold sintered compositions for 5-10 days, preferably 6-9 days, and preferably 7-8 days at a maximum temperature of 50 degrees Celsius (° C.) in a sealed container to form a brick. The composition may be dried with heating appliances such as ovens, vacuum ovens, microwaves, autoclaves, hot plates, heating mantles and tapes, oil baths, salt baths, sand baths, air baths, hot-tube furnaces, hot-air guns, a combination thereof, and the like. In a preferred embodiment, the composition may be dried for about 7 days in a sealed container to form the brick.

In some embodiments, the weight ratio of the uncalcined gypsum powder to the quartz material is 90:10 and the compressive strength of the brick is 35-42 MPa, preferably 36-41 MPa, preferably 37-40 MPa, and preferably 38-39 MPa. In one embodiment, the weight ratio of the uncalcined gypsum powder to the quartz material is 90:10 and the compressive strength of the brick is about 37 MPa. In another embodiment, the weight ratio of the uncalcined gypsum powder to the quartz material is 90:10 and the compressive strength of the brick is about 40 MPa. In some embodiments, the quartz material is quartz sand, and the compressive strength of the brick is 39-41 MPa, preferably 39.1-40.9 MPa, preferably 39.2-40.8 MPa, preferably 39.3-40.7 MPa, preferably 39.4-40.6 MPa, preferably 39.5-40.5 MPa, preferably 39.6-40.4 MPa, preferably 39.7-40.3 MPa, preferably 39.8-40.2 MPa, more preferably 39.9-40.1 MPa, and yet more preferably about 40 MPa.

In some embodiments, the uncalcined gypsum powder is calcium sulfate dihydrate (CaSO₄·2H₂O). In some embodiments, the uncalcined gypsum powder has an average particle size of 100-130 micrometers (μm), preferably 101-129 μm, preferably 102-128 μm, preferably 103-127 μm, preferably 104-126 μm, preferably 105-125 μm, preferably 106-124 μm, preferably 107-123 μm, preferably 108-122 μm, preferably 109-121 μm, preferably 110-120 μm, preferably 111-119 μm, preferably 112-118 μm, preferably 113-117 μm, preferably 114-116 μm, and preferably about 115 μm. In a preferred embodiment, the uncalcined gypsum powder has an average particle size of about 112 μm.

In some embodiments, a median particle size for the quartz sand is 350-390 μm, preferably 352-388 μm, preferably 354-386 μm, preferably 356-384 μm, preferably 358-382 μm, preferably 360-380 μm, preferably 362-378 μm, preferably 364-376 μm, preferably 366-374 μm, preferably 368-372 μm, and preferably about 370 μm. In a preferred embodiment, a median particle size for the quartz sand is about 368 μm. In some embodiments, a median particle size for the quartz powder is 10-20 μm, preferably 11-19 μm, preferably 12-18 μm, preferably 13-17 μm, preferably 14-16 μm, and preferably about 15 μm. In a preferred embodiment, a median particle size for the quartz powder is about 14 μm.

In some embodiments, the weight ratio of the uncalcined gypsum powder to the quartz material is 70:30 and the compressive strength of the brick is 20-35 MPa, preferably 21-34 MPa, preferably 22-33 MPa, preferably 23-32 MPa, preferably 24-31 MPa, preferably 25-30 MPa, preferably 26-29 MPa, and preferably 27-28 MPa. In one embodiment, the weight ratio of the uncalcined gypsum powder to the quartz material is 70:30 and the compressive strength of the brick is about 22 MPa. In another embodiment, the weight ratio of the uncalcined gypsum powder to the quartz material is 70:30 and the compressive strength of the brick is about 34 MPa.

In some embodiments, the method further includes mixing a talc with the uncalcined gypsum powder and the quartz material in an amount of 2-6 weight percent (wt. %), preferably 2.5-5.5 wt. %, preferably 3-5 wt. %, preferably 3.5-4.5 wt. %, and preferably about 4 wt. % based on the total weight of the mixture. In an embodiment, the method further includes mixing a talc with the uncalcined gypsum powder and the quartz material in an amount of about 2.5 wt. % based on a total weight of the mixture. In another embodiment, the method further includes mixing a talc with the uncalcined gypsum powder and the quartz material in an amount of about 5 wt. % based on a total weight of the mixture. Talc is a naturally occurring mineral composed mainly of magnesium, silicon, and oxygen. Talc serves as a lubricant, improving the flow of the mixture and facilitating easier processing. Talc may also enhance the thermal stability of a material (i.e., the brick), contributing to its strength and texture for better overall performance.

In some embodiments, the method further includes mixing a calcium carbonate powder with water to form a calcium carbonate mixture. In some embodiments, the calcium carbonate mixture includes malachite and azurite. In some embodiments, the calcium carbonate mixture may also include dolomite, aragonite, calcite, limestone, chalk, marble, travertine, and/or shells. In some embodiments, the calcium carbonate powder includes calcite in an amount of 25-30 wt. %, preferably 26-29 wt. %, and preferably 27-28 wt. % and aragonite in an amount of 70-75 wt. %, preferably 71-74 wt. %, and preferably 72-73 wt. % based on a total weight of the calcium carbonate powder. In a preferred embodiment, the calcium carbonate powder includes about 27% calcite and about 73% aragonite based on a total weight of the calcium carbonate powder.

In some embodiments, a weight ratio of water to the calcium carbonate powder in the mixture is from 0.05:1-0.25:1, preferably 0.06:1-0.24:1, preferably 0.07:1-0.23:1, preferably 0.08:1-0.22:1, preferably 0.09:1-0.21:1, preferably 0.1:1-0.2:1, preferably 0.11:1-0.19:1, preferably 0.12:1-0.18:1, preferably 0.13:1-0.17:1, preferably 0.14:1-0.16:1, and preferably about 0.15:1. The water may be tap water, distilled water, bidistilled water, deionized water, deionized distilled water, reverse osmosis water, salt water, a combination thereof, and/or some other water. In a preferred embodiment, the water is distilled water.

In some embodiments, the method further includes coating an outer surface of the brick with 1 to 5 layers, preferably 2 to 4 layers, and preferably about 3 layers of the calcium carbonate mixture. Coating techniques for the outer surface of the brick may include spray coating, dip coating, brush coating, roller coating, powder coating, a combination thereof, and the like. In some embodiments, the method further includes cold sintering the calcium carbonate coated brick with cyclic loading at a pressure of 80-120 MPa, preferably 81-119 MPa, preferably 82-118 MPa, preferably 83-117 MPa, preferably 84-116 MPa, preferably 85-115 MPa, preferably 86-114 MPa, preferably 87-113 MPa, preferably 88-112 MPa, preferably 89-111 MPa, preferably 90-110 MPa, preferably 91-109 MPa, preferably 92-108 MPa, preferably 93-107 MPa, preferably 94-106 MPa, preferably 95-105 MPa, preferably 96-104 MPa, preferably 97-103 MPa, preferably 98-102 MPa, preferably 99-101 MPa, and preferably about 100 MPa at room temperature for 10-20 min, preferably 11-19 min, preferably 12-18 min, preferably 13-17 min, preferably 14-16 min, and preferably about 15 min.

In some embodiments, the cold sintered calcium carbonate coated brick includes a water-resistant calcium carbonate layer on the brick. In some embodiments, the water-resistant calcium carbonate layer has a thickness of 0.5-3 cm, preferably 0.6-2.9 cm, preferably 0.7-2.8 cm, preferably 0.8-2.7 cm, preferably 0.9-2.6 cm, preferably 1-2.5 cm, preferably 1.1-2.4 cm, preferably 1.2-2.3 cm, preferably 1.3-2.2 cm, preferably 1.4-2.1 cm, preferably 1.5-2 cm, preferably 1.6-1.9 cm, and preferably 1.7-1.8 cm on the outer surface of the brick.

In some embodiments, the method further includes drying the cold sintered calcium carbonate coated brick for 5-10 days, preferably 6-9 days, and preferably 7-8 days at 50° C. In a preferred embodiment, the cold sintered calcium carbonate coated brick may be dried for about 7 days in a sealed container. In some embodiments, the mixing, cold sintering and drying are carried out in the absence of a cement and/or a calcined gypsum.

In some embodiments, the method further includes grinding the brick to form a recycled material. Exemplary techniques for grinding include, but not limited to, manual grinding methods such as mortar and pestle, hand-held grinders, and manual ball mills, and mechanical methods such as jet milling, vibratory milling, hammer milling, planetary milling, cryogenic grinding, a combination thereof, and/or any other apparatus known to those of ordinary skill in the art. Grinding provides efficient and consistent particle size reduction.

In some embodiments, the method further includes cold sintering the recycled material in a mold and drying the cold sintered recycled material to form a recycled brick. The cold sintered recycled material may be dried using heating appliances such as ovens, vacuum ovens, microwaves, autoclaves, hot plates, heating mantles and tapes, oil baths, salt baths, sand baths, air baths, hot-tube furnaces, hot-air guns, a combination thereof, and the like. In some embodiments, the recycled brick has a compressive strength 1.4 to 2 times, preferably 1.5 to 1.9 times, preferably 1.6 to 1.8 times, and preferably about 1.7 times greater than the brick.

### Examples

The following examples describe and demonstrate a method of brick production. The examples are provided solely for illustration and are not to be construed as limitations of the present disclosure, as many variations thereof are possible without departing from the spirit and scope of the present disclosure.

### Example 1: Materials and Methods

Gypsum powder was obtained by grinding satin spar (fibrous gypsum) vein sampled from the Lower Jurassic Marrat Formation, Central Saudi Arabia. Gypsum powder had preferably a fine grain size, ideally in the range of a few micrometers or submicron. Gypsum was ground utilizing a steel vibratory disc mill for 3 minutes (min). The sand was quartz sand from the Nafud desert in northern Saudi Arabia. Sand had no specific requirement on grain size. Quartz powder (silica flour) was produced by a local supplier. Calcium carbonate powder had a fine grain size, ideally in the range of a few micrometers (μm) or submicron.

After mixing gypsum powder with either quartz sand or quartz powder, distilled water was introduced to all samples, maintaining a water-to-mixture ratio of ≤0.1. Subsequently, the mixture underwent cold sintering utilizing an automatic hydraulic press machine (TMAX-ZYP, TMAXCN, China) in 20 millimeters (mm) die at room temperature. Lastly, the sintered samples were allowed to dry for a week in sealed containers at 50 degrees Celsius (° C.). The brick produced by this method is referred to as a “sand rose brick.” Table 1 summarizes details of various cold-sintering experiments. It includes information about the materials used in each experiment and specific conditions under which the cold-sintering process was carried out.

The impact of different ratios of gypsum to quartz sand by adjusting the gypsum weight percentage to represent 10%, 30%, 50%, 70%, and 90% were studied. Similar ratios were examined with the substitution of quartz powder instead of quartz sand to assess whether particle size of the insoluble particle inclusion influences the strength of sintered samples. Samples were cold sintered using 300 megapascals (MPa) for 30 min. To investigate whether a rise in applied pressure would enhance the unconfined compressive strength (UCS) of the cold-sintered samples, gypsum-quartz mixtures were tested under a pressure of 400 MPa.

Different concentrations of talc (0%, 2.5%, and 5%) were introduced into samples including equal amounts of gypsum and quartz powders.

Two series of experiments were conducted to investigate how the mode of loading (static vs. cyclic) during cold sintering affects the compressive strength of sintered samples. The first set aimed to determine whether a strength improvement occurred when subjecting the material to cyclic loading, as opposed to static loading, while keeping the total pressing time (30 min) and pressure (400 MPa) constant. The second set aimed to assess whether an increased number of cyclic loading cycles could achieve results comparable to samples cold-sintered at higher static pressures and/or gypsum percentages. For this purpose, samples with different gypsum-to-sand ratios were cold-sintered at various pressures (100 MPa, 200 MPa, 300 MPa, 400 MPa) with the same number of cycles (100 cycles) and total pressing time (30 min).

To assess recyclability, sintered samples made of equal parts gypsum and quartz sands were initially tested for compressive strength. Following this, the samples were ground, sintered again, and then subjected to mechanical testing once more to compare the results.

To assess the practicality of adding an outer layer with low solubility to the cold sintered gypsum-quartz mixture and assess its effect on the UCS, samples containing equal parts of gypsum and quartz sands were prepared. Coating layers composed of calcium carbonate powder, derived from grinding Red Sea beach sands, were then applied below and above the gypsum-quartz mixture. Three layers were then cold sintered in a single step. The resulting sintered samples with the coating were then subjected to mechanical testing to assess the impact of applying an outer layer on compressive strength. For aesthetic enhancement, the calcium carbonate coating layers were mixed with other naturally colored carbonate minerals such as azurite (Cu₃(CO₃)₂(OH)₂) and malachite (Cu₂CO₃(OH)₂). Afterward, the coated samples underwent a single-step cold sintering process.

For the purpose of comparison, concrete brick reference samples matching the size of the cold-sintered samples (20 mm diameter×25 mm length) were prepared. The concrete bricks were produced by combining 1 part ordinary Portland cement (OPC) with 3, 5, and 7 parts sand, mixed with a 0.1/cement water ratio, and subjected to a pressure of 50 MPa for a few seconds. After one day, the samples were cured for 28 days in a water container.

### Example 2: Characterization

X-ray diffraction (XRD) was utilized to verify the mineralogy of the materials used. Samples were ground in a mill (MM 400, Retsch) for 2 min. A PANalytical Empyrean diffractometer was used to record the XRD patterns at 45 kilovolts (kV) and 40 milliamperes (mA), using CuKα radiation. The samples were scanned from 4 to 70° 2θ with a 0.01° 2θ increment and a counting time of 40 seconds per increment. Powder diffraction patterns were analyzed using the Match software. A laser diffraction particle size analyzer (HELOS/R, Sympatec GmbH) was employed to measure the particle size distribution of the powders and sands.

Scanning electron microscopy (SEM, FEI Helios Nanolab G3 UC) with an energy-dispersive X-ray spectroscopy detector (EDS, Bruker) was used to observe the morphology, granularity, and elemental maps of the cold-sintered samples.

### Example 3: Unconfined Compressive Strength Test

The unconfined compressive strength (UCS) of the cold-sintered samples was evaluated using a Cyber-plus progress compression testing machine (Matest S.p.A, Treviolo, Italy). The load was applied at a rate of 1 kilonewton per second (kN/s), a start load of 0.5 kN, and a stop load of 30%. The resulting data points represent the average of multiple readings.

TABLE 1
List of cold-sintering experiments, detailing their compositions
and the conditions under which they were conducted.

| | Sample | Quartz | Gypsum | Talc | Pressure | | |
|---|---|---|---|---|---|---|---|
| | Label | (%) | (%) | (%) | (MPa) | Cycles | Time |
| Effect of | G90Q | 10 | 90 | 0 | 300 | 0 | 30 |
| sand to | G70Q | 30 | 70 | 0 | 300 | 0 | 30 |
| gypsum | G50Q | 50 | 50 | 0 | 300 | 0 | 30 |
| ratio | G30Q | 70 | 30 | 0 | 300 | 0 | 30 |
| | G10Q | 90 | 10 | 0 | 300 | 0 | 30 |
| Effect of | G90q | 10 | 90 | 0 | 300 | 0 | 30 |
| sand size | G70q | 30 | 70 | 0 | 300 | 0 | 30 |
| | G50q | 50 | 50 | 0 | 300 | 0 | 30 |
| | G30q | 70 | 30 | 0 | 300 | 0 | 30 |
| | G10q | 90 | 10 | 0 | 300 | 0 | 30 |
| Effect of | G50q − 0t | 50 | 50 | 0 | 300 | 0 | 15 |
| talc | G50q + 2.5t | 48.75 | 48.75 | 2.5 | 300 | 0 | 15 |
| addition | G50q + 5t | 47.5 | 47.5 | 5 | 300 | 0 | 15 |
| Effect of | G50Q − 300 | 50 | 50 | 0 | 300 | 0 | 30 |
| applied | G30Q − 300 | 70 | 30 | 0 | 300 | 0 | 30 |
| pressure | G10Q − 300 | 90 | 10 | 0 | 300 | 0 | 30 |
| | G50Q − 400 | 50 | 50 | 0 | 400 | 0 | 30 |
| | G30Q − 400 | 70 | 30 | 0 | 400 | 0 | 30 |
| | G10Q − 400 | 90 | 10 | 0 | 400 | 0 | 30 |
| Effect of | G50Q − 400 − 0c | 50 | 50 | 0 | 400 | 0 | 30 |
| mode | G30Q − 400 − 0c | 70 | 30 | 0 | 400 | 0 | 30 |
| | G10Q − 400 − 0c | 90 | 10 | 0 | 400 | 0 | 30 |
| | G50Q − 400 − 100c | 50 | 50 | 0 | 400 | 100 | 30 |
| | G30Q − 400 − 100c | 70 | 30 | 0 | 400 | 100 | 30 |
| | G10Q − 400 − 100c | 90 | 10 | 0 | 400 | 100 | 30 |
| Effect of | G50Q − 400 − 100c | 50 | 50 | 0 | 400 | 100 | 30 |
| applied | G30Q − 400 − 100c | 70 | 30 | 0 | 400 | 100 | 30 |
| pressure | G50Q − 300 − 100c | 50 | 50 | 0 | 300 | 100 | 30 |
| and | G30Q − 300 − 100c | 70 | 30 | 0 | 300 | 100 | 30 |
| pressure | G50Q − 200 − 100c | 50 | 50 | 0 | 200 | 100 | 30 |
| mode | G30Q − 200 − 100c | 70 | 30 | 0 | 200 | 100 | 30 |
| | G50Q − 100 − 100c | 50 | 50 | 0 | 100 | 100 | 30 |
| | G30Q − 100 − 100c | 70 | 30 | 0 | 100 | 100 | 30 |
| Effect of | G50Q+ no CC | 50 | 50 | 0 | 300 | 0 | 15 |
| coating | G50Q+ with CC | 50 | 50 | 0 | 300 | 0 | 15 |
| Effect of | G50q − 15c | 50 | 50 | 0 | 300 | 15 | 15 |
| recycling | G50Q − 15c − R | 50 | 50 | 0 | 300 | 15 | 15 |
| | G50q − 15c − R | 50 | 50 | 0 | 300 | 15 | 15 |

G: gypsum powder.
Q: quartz sand.
q: quartz powder

XRD analysis verified that both the quartz sand and quartz powder utilized in this investigation consist entirely of α-quartz. The median particle size (D50) value for quartz sand is 368 μm. The median particle size (D50) value for quartz powder is 14 μm. The gypsum powder is pure, devoid of impurities, and possesses a D50 value of 112 μm. In the case of the calcium carbonate powder utilized, it is a mixture of calcite (27%) and aragonite (73%) with a D50 of 19 μm. The cumulative particle size distribution (top) and powder XRD patterns (bottom) of the initial materials are seen in FIG. 1B.

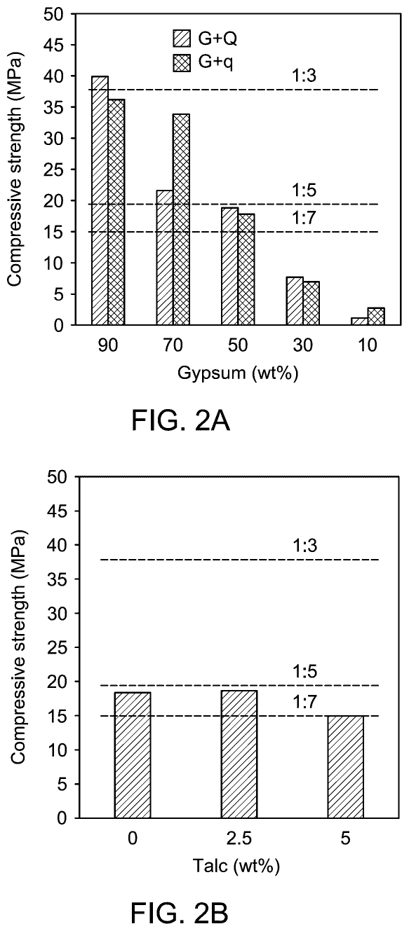

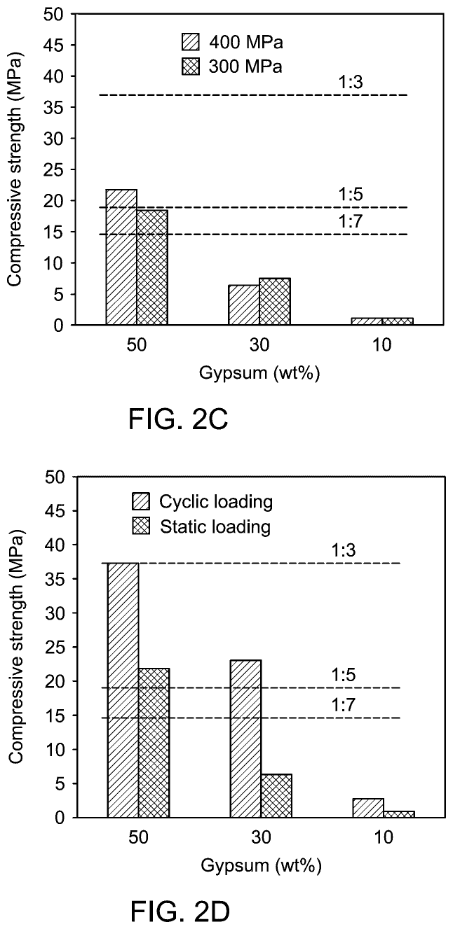

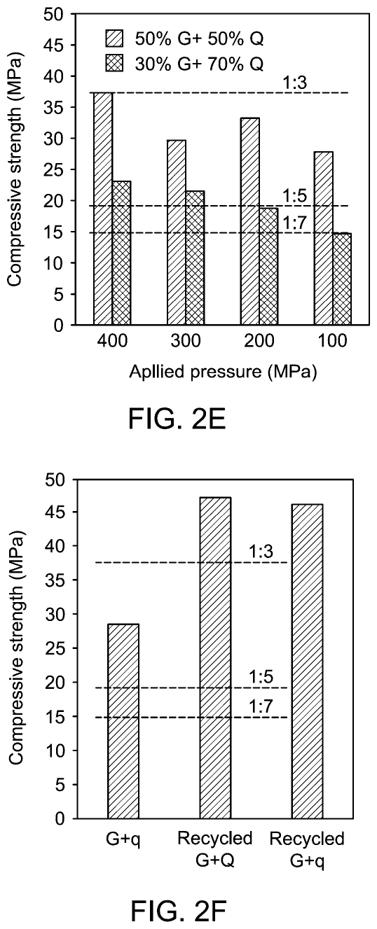

Various factors have been investigated to determine mechanical properties through cold sintering of a binder (gypsum) and filler (quartz sand or quartz powder) mixture. FIG. 2A illustrates how varying the amount of gypsum powder, serving as a binder, impacts the UCS of cold-sintered samples subjected to a pressure of 300 MPa for 30 min. Additionally, it compares the compressive strengths of concrete bricks (dashed lines) of similar dimensions to the cold-sintered samples. Altering the cement-to-sand ratio to 1:7, 1:5, and 1:3 results in increasing the UCS of the concrete bricks to 15, 19.5, and 33 MPa, respectively.

With an increase in the gypsum percentage, there is a corresponding rise in UCS. Increasing the gypsum content from 10% to 90% consistently increases UCS from below 3 MPa to above 35 MPa. When the gypsum content in cold-sintered samples is equal to or exceeds 50%, the UCS becomes comparable to that of concrete bricks with similar dimensions. Cold-sintered samples with less than 50% gypsum content exhibit substandard UCS values.

FIG. 2A depicts effects of gypsum percentage and quartz grain size on the UCS of a cold-sintered mixture of gypsum powder (G) with either quartz sand (Q) or quartz powder (q). Cold sintering was conducted with a static pressure of 300 MPa for 30 min. It examines the influence of filler size (quartz sand versus quartz powder) on the UCS of cold-sintered samples. For both types of filler, an increase in their content leads to a decrease in UCS. The differences in UCS between samples with quartz sand and quartz powder are generally small, ranging from 0.5 to 3.5 MPa, except for the sample with 70% gypsum powder; therefore, there may be no necessity for grinding sand as it may be utilized in its natural state.

FIG. 2B depicts the impact of introducing talc as a lubricant on the unconfined compressive strength (UCS) of a cold-sintered mixture including 50% gypsum powder and 50% quartz powder under a pressure of 300 MPa for 15 min. The results indicate that the addition of 2.5 wt. % talc did not result in a large alteration in the UCS; however, when 5 wt. % talc was added, the UCS was adversely affected, showing an 18% decrease. Even though the inclusion of a lubricant can increase quartz packing density, this compaction fails to generate sintering in the quartz at room temperature.

FIG. 2C demonstrates that raising the applied pressure from 300 MPa to 400 MPa leads to an 18% enhancement in the UCS of cold-sintered samples including 50% gypsum; however, there is no discernible alteration in samples with lower proportions of gypsum.

FIG. 2D illustrates that cyclic loading can enhance the UCS of cold-sintered samples when compared to samples subjected to a static load of equivalent magnitude and duration. In the case of samples containing 50% gypsum, the increase was 70%, while for those with 30% gypsum, it surpassed 250%. Although the UCS values for samples with 10% gypsum witnessed an increase of 150%, they remain low.

Numerous other minerals, such as halite and calcite, also experienced a rise in creep rate when transitioning from static to cyclic loading. In the unloading phase, convection currents arise from the expansion of interlayers between grains, causing a rapid decrease in supersaturation in the contact zone. This results in the material coming into contact with a less saturated solution. Subsequently, at the beginning of each loading phase, supersaturation restarts. The extent of creep acceleration varies based on material properties, applied stress, and cycling frequency.

Cold-sintered samples with a gypsum percentage starting from 30% have demonstrated satisfactory UCS values under cyclic loading of 400 MPa. Examining minimum cyclic pressure required to attain satisfactory UCS values with low gypsum content facilitates the upscaling process. FIG. 2E illustrates how varying cyclic pressure influences the UCS values of cold-sintered samples containing 30% and 50% gypsum content. FIG. 2E depicts effects of cyclic loading (100 cycles) on the UCS of cold-sintered gypsum-quartz sand mixtures. Cold sintering was carried out using different gypsum percentages and different applied pressures for 30 minutes. FIG. 2F depicts effects of recycling on the UCS of a cold-sintered mixture of equal proportion of gypsum powder and quartz. Cold sintering was carried out using cyclic (15 cycles) pressures of 300 MPa for 15 min. Although reducing the applied pressure leads to a decrease in the values of UCS, the decrease is less than 1 MPa. The results indicate that acceptable UCS values can be achieved with lower cyclic pressures. Samples containing 50% gypsum can reach UCS values greater than the concrete bricks with cyclic pressure as low as 100 MPa. The trend suggests that even lower pressures may suffice. For samples with 30% gypsum, satisfactory UCS values are attainable with cyclic pressures exceeding 100 MPa. This further confirms that cyclic loading is an effective approach in achieving higher UCS values in gypsum without the need to either increase the gypsum amount or increase the amount of applied pressure.

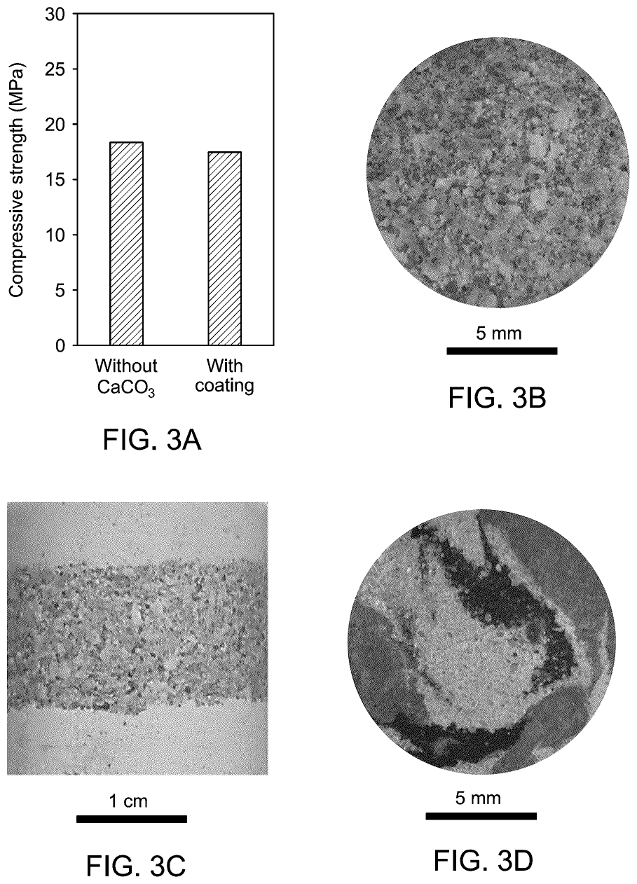

FIG. 3A depicts effects of applying calcium carbonate coatings on the UCS of a cold-sintered mixture including 50% gypsum powder and 50% quartz sand under a pressure of 300 MPa for 15 min. The findings show that addition of the coating does not decrease the UCS of the cold-sintered samples. The appearance of the coating can be enhanced by mixing it with naturally colored minerals such as malachite and azurite. FIG. 3B is a photomicrograph taken under stereomicroscopic viewing of a cold-sintered gypsum powder-quartz sand mixture. FIG. 3C is a photomicrograph of a side view of a cold sintered mixture of gypsum powder and quartz sand with an upper and lower calcium carbonate coating. FIG. 3D is a photomicrograph of a top view of the calcium carbonate coating mixed with azurite and malachite.

The coating may serve various purposes, including protection against solubility and abrasion. This is attributed to the lower solubility and higher hardness of carbonate minerals in comparison to gypsum. Gypsum has a solubility of 2.4 grams per liter (g/L), whereas carbonate minerals have solubilities ranging from 0.06 to 0.4 g/L. Additionally, while gypsum has a hardness of 2, carbonate minerals exhibit a hardness equal to or greater than 3.

UCS values of cold-sintered calcium carbonate powders are influenced by particle size. When cold-sintered with deionized water and subjected to a uniaxial pressure of 100 MPa for 30 min at room temperature, submicron-sized powder (50-300 nanometers (nm) calcite) exhibited a 573% increase in UCS compared to micron-sized powders (10-35 μm calcite) [Cao, M. et al., Dense and strong calcite ceramics prepared by room-temperature cold sintering based on high-pressure-enhanced solubility, J. Am. Ceram. Soc., 2023, 106, 1668-1680, which is incorporated herein by reference in its entirety]. This enhancement emphasizes the use of submicron-sized calcium carbonate powders for coating the sand-gypsum mixture.

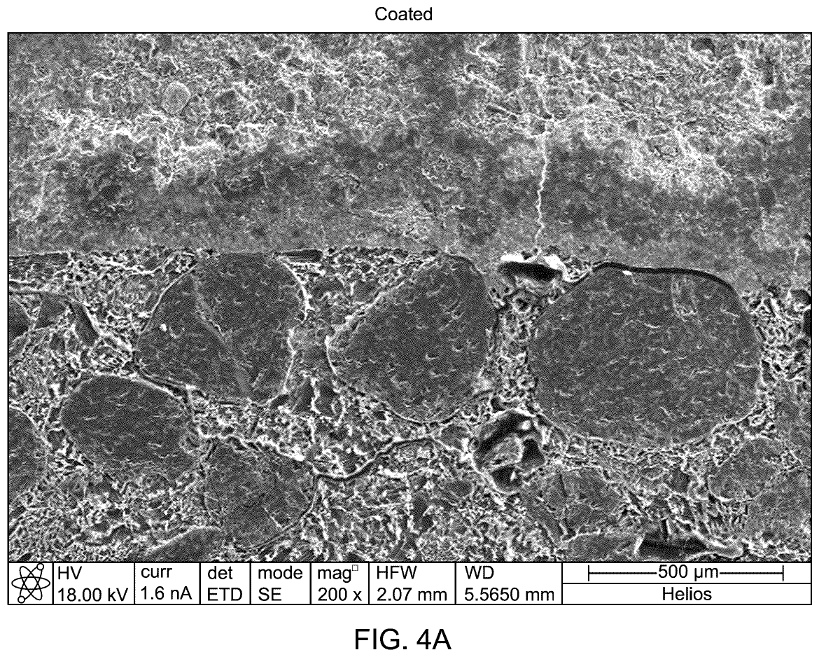

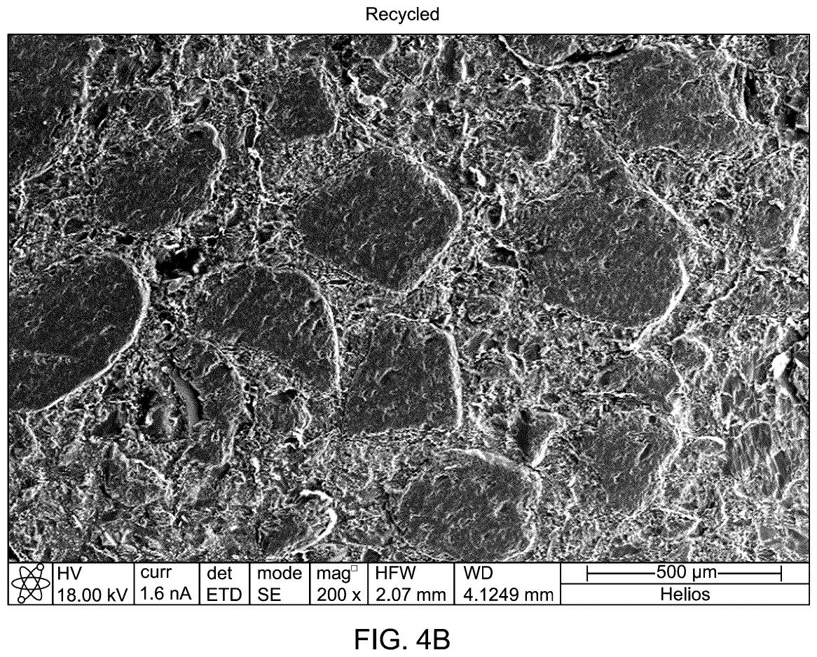

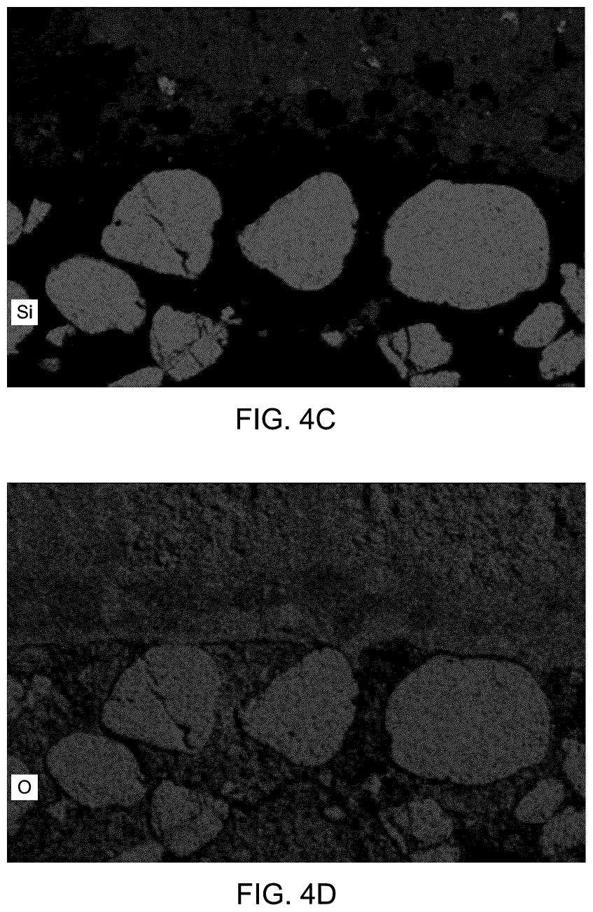

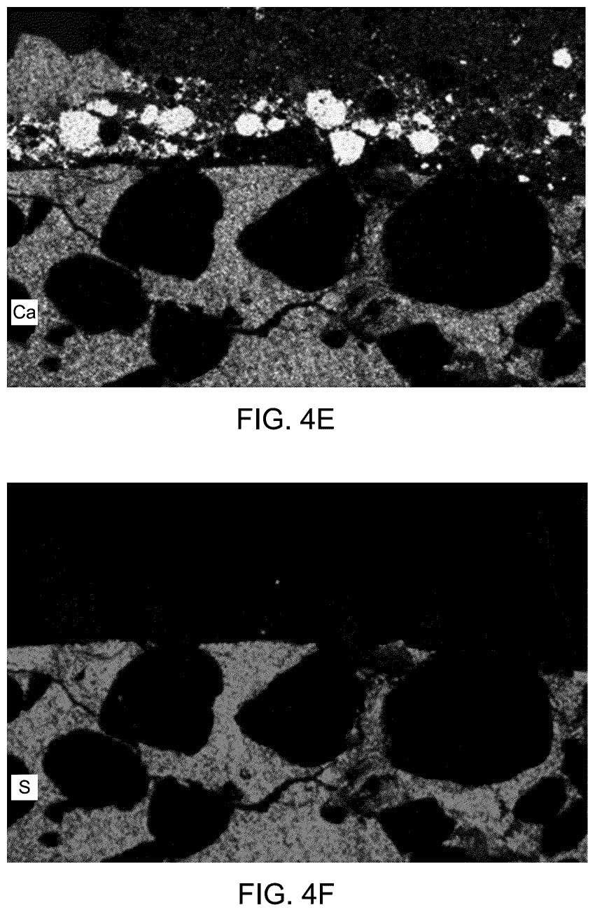

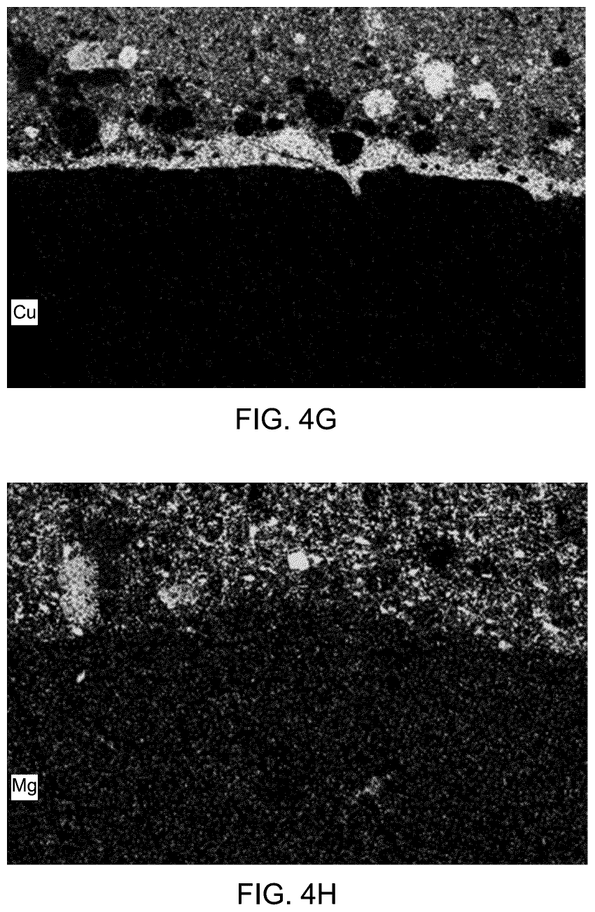

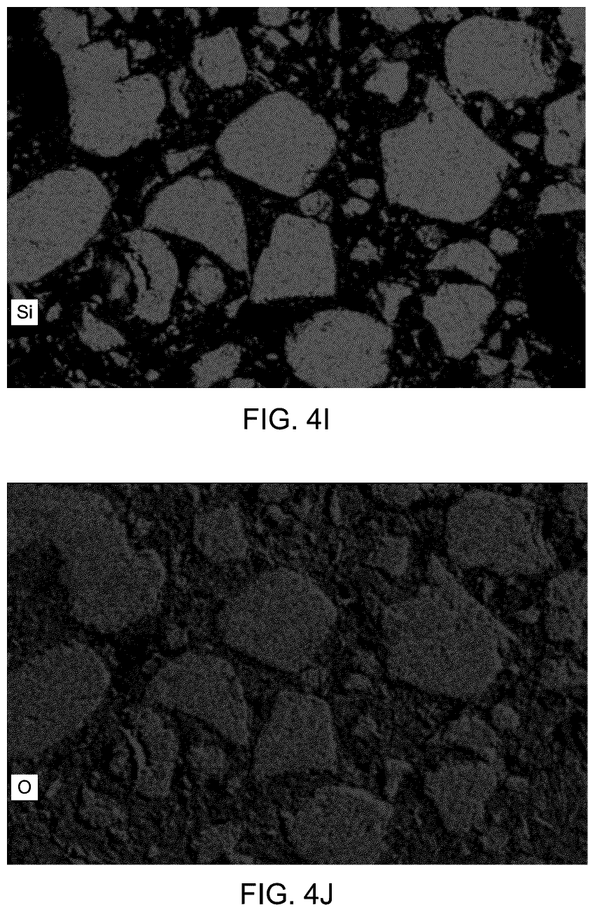

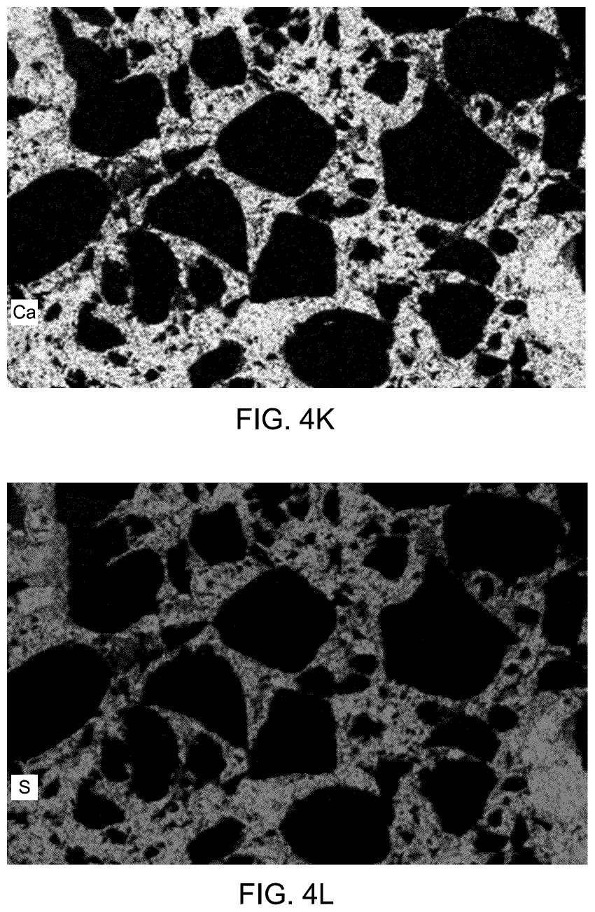

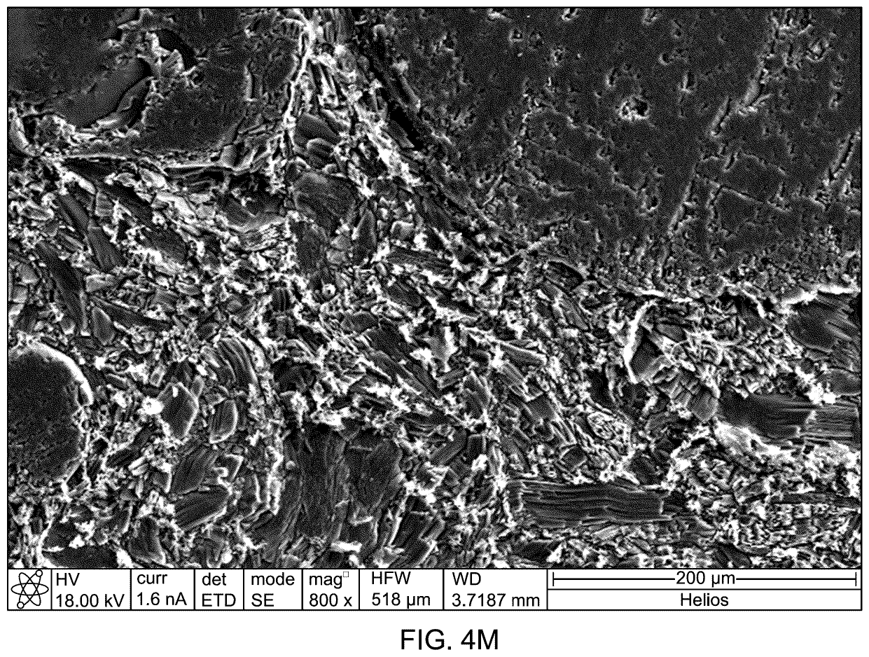

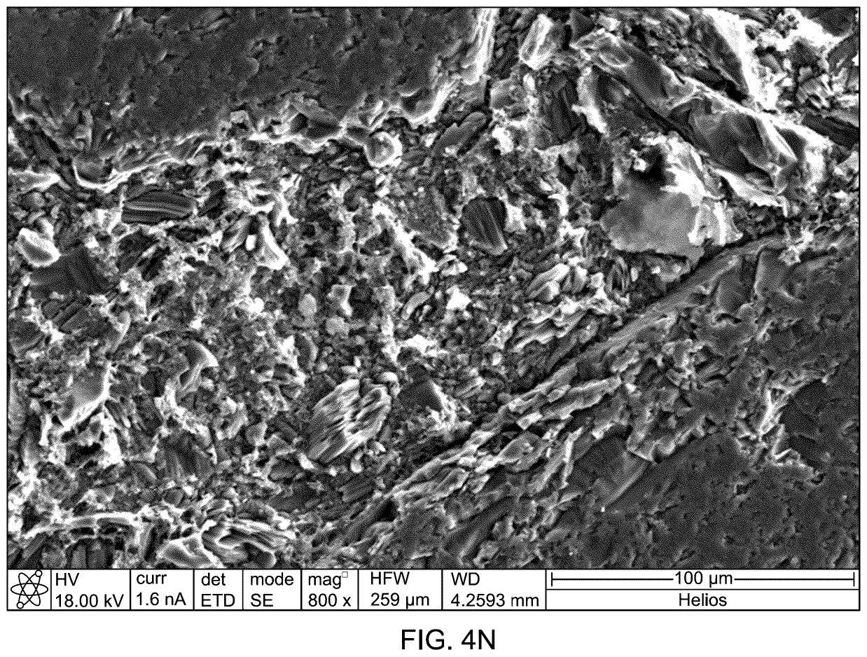

FIG. 4A is a scanning electron microscopy (SEM) image of an interface between an upper (outer) layer, composed of a mixture of calcium carbonate powder, azurite, and malachite, and the lower (inner) layer including gypsum powder mixed with quartz sand. FIG. 4B is an SEM image of a recycled cold-sintered gypsum powder-quartz sand mixture with a scale of 500 μm. The elemental distribution maps obtained via EDS further delineate the constituents. FIGS. 4C-4H depict elemental mapping images of a coated cold-sintered gypsum powder-quartz sand mixture. FIGS. 4C-FIG. 4H are elemental mapping images depicting the presence of silicon (Si), oxygen (O), calcium (Ca), sulfur(S), copper (Cu), and magnesium (Mg), respectively. Silicon and oxygen correspond to the quartz sand. Sulfur signifies the presence of gypsum among the quartz grains. The EDS map of copper depicts the distribution of azurite and malachite within the calcium carbonate coating. FIGS. 4I-4L are elemental mapping images of recycled cold-sintered gypsum powder-quartz sand mixture depicting the presence of Si, O, Ca, and S, respectively. FIGS. 4M-4N are magnified SEM images of the coated and recycled cold-sintered gypsum powder-quartz sand mixtures with a scale of 200 μm, respectively. Microscopic examination of the recycled sample (FIG. 4M) reveals that gypsum grains are smaller compared to those in the original sample (FIG. 4N). The decrease in gypsum grain size and the improved homogeneity within the sample, possibly resulting from the grinding of the sample to produce recycled samples, may enhance the sintering process.

Varying factors, including decreasing the size of gypsum particles and employing cyclic loading, may enhance UCS values of sand-gypsum mixtures containing less than 50% gypsum. Applying higher pressures during loading also has a positive effect on UCS values. Conversely, reducing the size of quartz particles and adding a lubricant have minimal influence on UCS and may result in a negative impact. Recycling the cold-sintered sand-gypsum mixture and applying a calcium carbonate coating to the sand-gypsum mixture both do not undermine the UCS of the cold-sintered samples and may lead to a more water-resistant material.

Sustainable materials from local areas and energy-efficient and low-carbon production method were employed to develop alternative and sustainable bricks. By cold sintering sand-gypsum mixtures, sustainable bricks that possess similar mechanical characteristics to conventional bricks were produced. Various factors, including sand-to-gypsum ratios, sand size, talc addition, applied pressure, pressure mode, recycling, and a calcium carbonate coating, were used to determine the UCS of cold-sintered sand-gypsum mixtures. Parameters such as increasing the gypsum percentage, reducing the size of gypsum particles, applying higher pressures, and employing cyclic loading enhance the UCS values of sand-gypsum mixtures. Cyclic loading enhances the UCS of cold-sintered samples compared to those under a static load of the same intensity and duration. It is an efficient method for achieving higher UCS values without needing to increase gypsum quantity or applied pressure. Reducing the size of quartz particles and incorporating a lubricant have minimal impact on UCS. The one-step sintering process of the gypsum-quartz mixture with a calcium carbonate coating has minimal adverse effects that do not compromise its mechanical performance. Because sand is more accessible, gypsum percentage needs to be kept to a minimum. To make upscaling easier, applied pressure should be kept to a minimum. By using a low gypsum content (ranging from 30% to 50%) and applying a pressure of 100 MPa in a cyclic mode for 15 min, bricks can achieve UCS values equal to or better than concrete bricks of the same size. Implementing this approach may contribute to multiple sustainability development goals. Utilization of inexpensive and readily accessible raw materials, particularly in developing countries, can facilitate building affordable housing. The production method, which is characterized by low energy requirements and the absence of carbon emissions, can lead to cleaner industrial processes while reducing energy and water consumption. Successful demonstration of recycling waste bricks aids in waste reduction and promotes efficient utilization of natural resources.

Numerous modifications and variations of the present disclosure are possible in light of the above teachings. Therefore, it is to be understood that within the scope of the appended claims, the disclosure may be practiced other than as specifically described herein.

1. A method of brick production, including:
mixing an uncalcined gypsum powder and a quartz material to form a mixture,
wherein the quartz material is selected from a group consisting of a quartz sand and a quartz powder,
wherein a weight ratio of the uncalcined gypsum powder to the quartz material is from 5:95 to 95:5,
mixing the mixture with water to form a composition,
wherein a weight ratio of the water to the mixture is from 0.01:1 to 0.15:1, cold sintering the composition in a mold at a pressure of 50 to 450 megapascal (MPa) at room temperature for 20 to 40 minutes (min); and
drying the cold sintered compositions for 5 to 10 days at a maximum temperature of 50 degrees Celsius (° C.) in a sealed container to form a brick.

2. The method of claim 1, wherein the weight ratio of the uncalcined gypsum powder to the quartz material is 90:10 and the compressive strength of the brick is 35 to 42 MPa.

3. The method of claim 2, wherein the quartz material is quartz sand, and the compressive strength of the brick is 39 to 41 MPa.

4. The method of claim 1, wherein the weight ratio of the uncalcined gypsum powder to the quartz material is 70:30 and the compressive strength of the brick is 20 to 35 MPa.

5. The method of claim 1, wherein the cold sintering process is selected from a group consisting of static loading and cyclic loading.

6. The method of claim 1, wherein the cold sintering process includes cyclic loading including 80 to 120 cycles of repetitive applied pressure followed by no applied pressure.

7. The method of claim 6, wherein after cold sintering with cyclic loading the brick has a compressive strength 1.5 to 5 times greater than a brick cold sintered with static loading.

8. The method of claim 1, further including:
mixing a talc with the uncalcined gypsum powder and the quartz material in an amount of 2 to 6 weight percent (wt. %) based on the total weight of the mixture.

9. The method of claim 1, further including:
mixing a calcium carbonate powder with water to form a calcium carbonate mixture,
wherein a weight ratio of water to the calcium carbonate powder in the mixture is from 0.05:1 to 0.25:1,
coating an outer surface of the brick with 1 to 5 layers of the calcium carbonate mixture;
cold sintering the calcium carbonate coated brick with cyclic loading at a pressure of 80 to 120 MPa at room temperature for 10 to 20 min; and
drying the cold sintered calcium carbonate coated brick for 5 to 10 days at 50° C.

10. The method of claim 9, wherein the calcium carbonate mixture includes malachite and azurite.

11. The method of claim 1, wherein the uncalcined gypsum powder is calcium sulfate dihydrate (CaSO₄·2H₂O).

12. The method of claim 1, wherein a median particle size for the quartz sand is 350 to 390 micrometers (μm).

13. The method of claim 1, wherein a median particle size for the quartz powder is 10 to 20 μm.

14. The method of claim 1, wherein the uncalcined gypsum powder has an average particle size of 100 to 130 μm.

15. The method of claim 9, wherein the calcium carbonate powder includes 25 to 30 wt. % calcite and 70 to 75 wt. % aragonite based on a total weight of the calcium carbonate powder.

16. The method of claim 1, wherein the mixing, cold sintering and drying are carried out in the absence of a cement and/or a calcined gypsum.

17. The method of claim 9, wherein the cold sintered calcium carbonate coated brick includes a water-resistant calcium carbonate layer on the brick.

18. The method of claim 17, wherein the water-resistant calcium carbonate layer has a thickness of 0.5 to 3 centimeters (cm) on the outer surface of the brick.

19. The method of claim 1, further including:
grinding the brick to form a recycled material;
cold sintering the recycled material in a mold; and
drying the cold sintered recycled material to form a recycled brick.

20. The method of claim 19, wherein the recycled brick has a compressive strength 1.4 to 2 times greater than the brick.
